(19) United States
(12) Patent Application Publication
(10) Pub. No.: US 2008/0019517 A1
(43) Pub. Date: Jan. 24, 2008

(54) Control work key store for multiple data streams

(76) Inventors: Peter Munguia, Chandler, AZ (US); Steve J. Brown, Phoenix, AZ (US); Dhiraj Bhatt, Portland, OR (US); Dmitrii Loukianov, Chandler, AZ (US)

Correspondence Address: TROP, PRUNER & HU, P.C., 1616 S. VOSS RD., SITE 750, HOUSTON, TX, 77057-2631, US

(21) Appl. No.: 11/399,714

(22) Filed: Apr. 6, 2006

(51) Int. Cl. H04N 7/167

(52) U.S. Cl. 380/210

(57) ABSTRACT

An apparatus may include circuitry, a cryptographic module, and a key store. The circuitry may hold a private key associated with first media information. The cryptographic module may operate on the private key to generate a number of first control keys for decrypting the first media information. The key store may hold the number of first control keys from the cryptographic module. In some implementations, the key store may include sufficient storage to store more than one control key from each of a number of different crypto modules. In some implementations, the key store may receive multiple control keys simultaneously or nearly so. In some implementations, the key store may output multiple control keys simultaneously, or nearly so, for decrypting multiple streams of media information at the same time.

### CROSS-REFERENCE TO RELATED APPLICATIONS

The present application is related to application Ser. No. ______, entitled “Method And Apparatus To Mate An External Code Image With An On-Chip Private Key” and filed Apr. 7, 2006 (Docket No. P24003); to application Ser. No. ______, entitled “Supporting Multiple Key Ladders Using A Common Private Key Set” and filed Apr. 6, 2006 (Docket No. P24004); and to application Ser. No. ______, entitled “Protecting Independent Vendor Encryption Keys With A Common Silicon Manufacturer's Key” and filed ______ (Docket No. P24005).

### BACKGROUND

Implementations of the claimed invention generally may relate to security schemes for decrypting encrypted media information and, more particularly, to such schemes that involve private keys resident in devices.

Traditionally in media delivery schemes, a media vendor (“vendor”) may supply (or cause to be supplied) to an end user decoder hardware for decoding encrypted media information that may be typically sent over a single transmission medium. The hardware may be specifically manufactured by the vendor by a partner manufacturer (“manufacturer”), who may embed a private key (which is a shared secret with the vendor) in the hardware for use in decrypting the media information. Special-purpose set-top boxes for receiving encrypted cable or satellite television from a vendor may be one example of such a typical arrangement.

In some cases, where the media information includes a stream of video, the vendor may send, from time to time, a new set of run time keys for use in decrypting or decoding the media information. The time that the receiving hardware takes to process the message containing the new keys to produce, for example, a new control word/key may be conceptualized as a “latency” before the decrypting/decoding may be begun with the new keys (e.g., the “context” of the processing may be “switched” to the context provided by the new keys). This processing delay before the decrypting or decoding context may be changed or switched to the new control word or key may be referred to as a “context switch latency.”

Recently, hybrid networked media products have begun to appear that may receive media information via a variety of different transmission paths and/or transmission media. Also, newer “content everywhere” models for usage and/or consumption of media information have begun to appear. Such newer hybrid devices that may support more than one vendor, and/or the availability of some media information via other paths that that preferred by a given vendor (e.g., Internet-based content), may not be well served by typical media security schemes.

### BRIEF DESCRIPTION OF THE DRAWINGS

The accompanying drawings, which are incorporated in and constitute a part of this specification, illustrate one or more implementations consistent with the principles of the invention and, together with the description, explain such implementations. The drawings are not necessarily to scale, the emphasis instead being placed upon illustrating the principles of the invention. In the drawings,

FIG. 1 conceptually illustrates a media receiving system;

FIG. 2 illustrates an exemplary security module and key store in the system of FIG. 1; and

FIG. 3 illustrates an exemplary cypto module in the security module of FIG. 2.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of the claimed invention. However, it will be apparent to those skilled in the art having the benefit of the present disclosure that the various aspects of the invention claimed may be practiced in other examples that depart from these specific details. In certain instances, descriptions of well known devices, circuits, and methods are omitted so as not to obscure the description of the present invention with unnecessary detail.

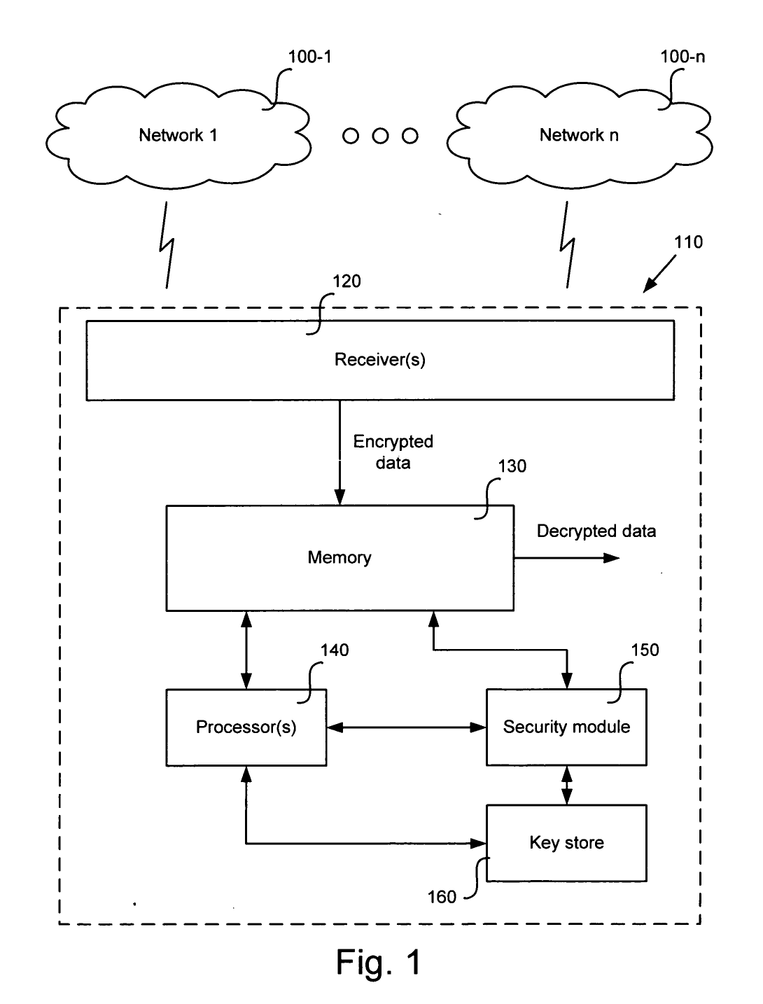

FIG. 1 illustrates a media receiving system. The system may include one or more networks 100-1, . . . , 100-n (collectively “networks 100”) to which a device 110 is communicatively connected. Device 110 may receive encrypted media information via any or all of networks 100 via any suitable medium, including but not limited to various wireless/wired transmission and/or storage media. The media information may include, but is not limited to, video, audio, software, graphical information, television, movies, music, finacial information, business information, entertainment information, communications, or any other media-type information that may be provided by a vendor and consumed by an end user. In some implementations, the media information may include plural streams of encrypted video information that may be received in parallel.

Device 110 may include one or more receivers 120, a memory 130, processor(s) 140, security module 150, and key store 160. Although illustrated as separate functional elements for ease of explanation, any or all of the elements of device 110 may be co-located and/or implemented by a common group of gates and/or transistors. For example, two or more of elements 120-160 may be implemented in a system on a chip (SOC). Further, device 110 may be implemented via software, firmware, hardware, or any suitable combination thereof. The implementations are not limited in these contexts.

Receivers 120 may be arranged to receive encrypted media information from a variety of transmission paths. Receivers 120 may include, for example, a wireless transceiver (e.g., for Bluetooth, WiFi, WiMax, or any other suitable high-speed wireless protocol), a wired transceiver (e.g., for Ethernet, coaxial cable, etc.), an optical transceiver, a satellite transceiver, and/or any other known circuitry for extracting a signal from a physical transmission medium or storage medium. Receivers 120 also may include any other circuitry for extracting a media information stream from a received signal. Such circuitry may include but is not limited to, for example, demodulators, multiple tuners, equalizers, etc.

Although not illustrated as being directly connected to processor(s) 140 for ease of presentation, receivers 120 may be controlled or otherwise facilitated by processor(s) 140. Receivers 120 may output one or more distinct chunks or streams of encrypted media information to memory 130.

Memory 130 may be arranged to temporarily store chunks and/or streams of encrypted (or in some implementations decrypted) media information. Memory 130 may include, for example, semiconductor and/or magnetic storage, and may be rewritable. In some implementations, memory 130 may include non-writable memory, such as read-only memory (ROM) (e.g., a boot ROM). In some implementations, memory 130 may include memory that is not readable by software, such as one or more hardware private keys set by the manufacturer of device 110. In other implementations, however, such private keys may be stored in security module 150.

Memory 130 may also be arranged to temporarily store information from the vendor that is not strictly media information. For example, in some implementations memory 130 may store messages including run time keys or control words (i.e., sent from the vendor and updateable, as opposed to resident in hardware on device 110). In such cases, these messages to deliver keys may be sent in sidebands (or other techniques that may be termed “out of band”) to the normal transport stream carrying the encrypted media information (e.g., video). In some implementations, memory 130 may also temporarily store encryption products or other security-related data from security module 150 and/or key store 160.

In some implementations, processor(s) 140 may use a control word from key store 160 to decrypt encrypted media information from receivers 120 “on the fly” before it is stored in memory 130. In such implementations, memory 130 may temporarily store decrypted media information. In other implementations, encrypted media information my be stored in memory 130 and decrypted when it is read out. Regardless of when the media information is decrypted, it may be output from memory 130 to another portion of device 110, such as a hard disk, display buffer, media-specific processor, etc. (not shown) for further processing or playback.

Processor(s) 140 may be arranged to control the input and output of media information to/from memory 130 and/or security module 150 and/or key store 160. Processor(s) 140 may also be arranged to decrypt encrypted media information, before or after residing in memory 130, using a decryption key (or control word) from key store 160. Processor(s) 140 may include a general-purpose or special-purpose processor, as well as any ancillary circuitry needed to perform its various functions, such as decrypting information with control words. In some implementations, processor(s) 140 may include multiple processors configured to read control words from key store 160 in parallel and/or decrypt media information in parallel.

Security module 150 may be arranged to store one or more private keys that are secret to at least the manufacturer of Security module 150 or device 110. One or more of the private keys in security module 150 may be shared secrets between the manufacturer and any of a number of different vendors. In addition to different, hardware-based private keys, security module 150 may include a number of different cryptographic (“crypto”) modules so that device 110 may provide media decryption, encryption, and/or media security for a number of different vendors that may provide encrypted media over a number of different data paths.

Key store 160 may be arranged to receive and store a relatively large number of control words (or “control keys”) that are produced by security module 150 (e.g., protected by the private key(s) therein). Key store 160 may be arranged so that it may be written to in parallel by security module 150 and/or read from in parallel by processor(s) 140. In some implementations, key store 160 may store control words/keys that are not produced by security module 150, but rather may arrive directly in a message from a vendor. Key store 160 may be sized so that it may hold sufficient control words to provide latency-free context switching for a relatively large number of streams of media information (e.g., 5, 10, 20 or more streams).

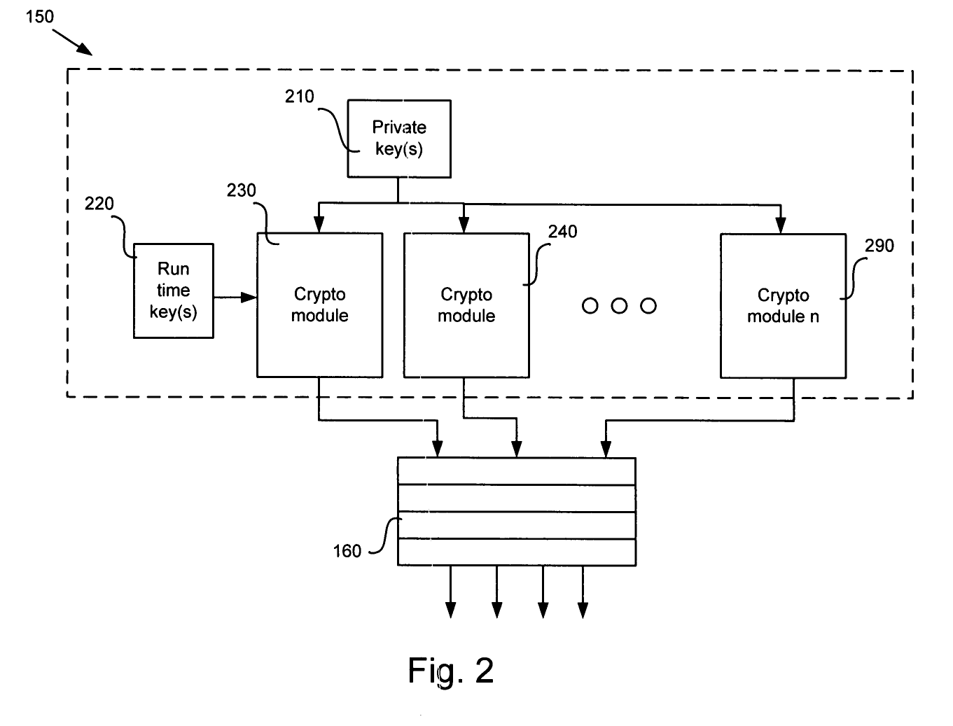

FIG. 2 illustrates an exemplary implementation of security module 150 and key store 160. Module 150 may include private key(s) 210, run time key(s) 220, a first crypto module 230, a second crypto module 240, other crypto modules (not shown), and an nth crypto module 290. Although private keys 210 and the various crypto modules 230-290 may be similarly illustrated, they may be differently implemented, and their details may be defined by different vendors (sometimes known as conditional access (CA) vendors).

Private key(s) 210 may reside in an externally unreadable (i.e., secure) circuit location within module 150, and may be shared secrets between the manufacturer of device 210 (or at least of the portion containing security module 150) and one or more vendors. Although only one private key 210 is illustrated, others may also be present, possibly including a multiplexer to deliver them to crypto modules 230-290. Only the manufacturer of security module 150 need be a party to the secret for each private key 210, because such may be permanently formed or embedded in module 150. The vendors need not have knowledge of any other private key 210 than their own. Also, one or more of private keys 210 may be secret to the manufacturer only.

First crypto module 230 may receive a private key 210, and may use this key 210 to encrypt certain data within module 230. In some implementations, this other data that is encrypted (or protected) by private key 210 may include one or more run time key(s) 220 that are sent (and possibly updated from time to time) by the vendor associated with first module 230. In some implementations, however, run time keys 220 may not be supplied, and module 230 may encrypt certain predefined data within it (e.g., manufacturer identifiers, etc.) with its private key 210. Again, module 230 may in some implementations encrypt with two or more private keys 210. First crypto module 230 may output a result for use by processor 140 in, for example, decrypting encrypted media information.

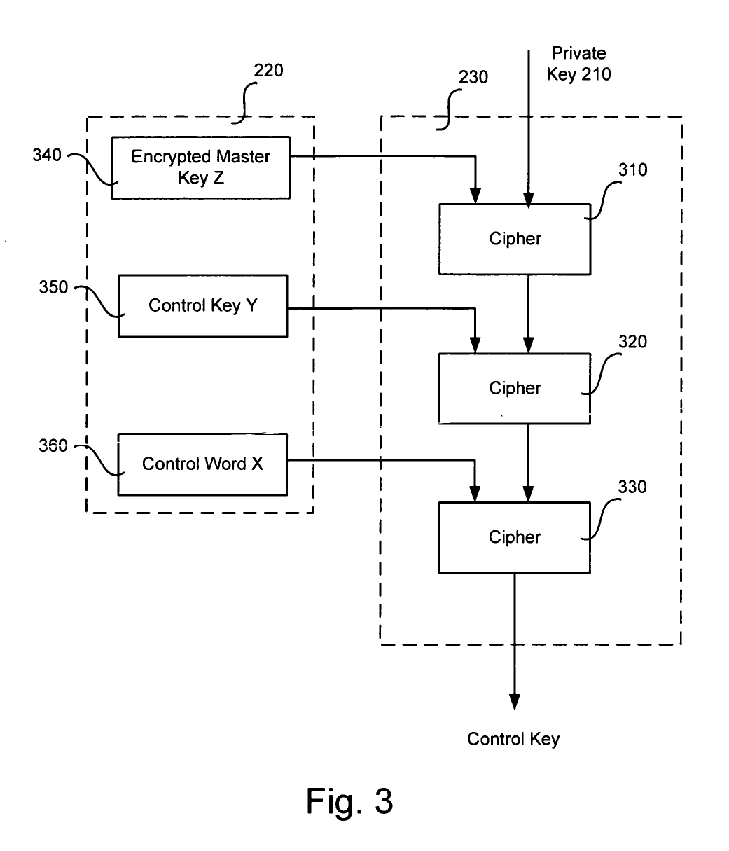

FIG. 3 illustrates an exemplary implementation of first cypto module 230 and run time keys 220. First crypto module 230 may include cipher blocks 310-330, and run time keys 220 may include an encrypted master key 340, a control key 350, and a control word 360. In such implementation, module 230 and keys 220 may be referred to as a “tiered key ladder,” because of the “ladder” of successive encryptions performed by cipher blocks 310-330.

This key ladder scheme may involve the private key being a shared secret with the vendor of media information. The vendor may also supply run time keys 340-360 that are encrypted by the shared secret private key via cipher blocks 340-360. The run time keys 220 may be decrypted by processor 140 and stored in module 150 such that the effective run time keys 340-360 are not visible outside of security module 150 (e.g., “off chip”). The run time key encryption process may include more than one layer of encryption and more than one externally supplied value.

For a 3-tiered example illustrated in FIG. 3, Control Word 360, CWx, may be encrypted with Control Key 350, CKy by cipher 330 to create an external value EncCW=E(CWx, CKy). Cipher 330 (and other ciphers 310 and 320) may employ any of a number of hardware-based encryption schemes, such as DES (Data Encryption Standard), AES (Advanced Encryption Standard), etc. Ciphers 310-330 need not all employ the same encryption algorithm, key length, etc., although they may. This external value EncCW may be the output of module 230. Likewise CKy 350 may be encrypted with the Master Key 340, MKz, by cipher 320 to create the external value EncCK=E(CKy, MKz). Similarly MKz 340 may be encrypted with the Private Key 210, PKa, to create the external value EncMKz =E(MKz, PKa). A control key (e.g., EncCW produced by cipher 330) that has been protected by private key 210 may be output by first crypto module 230 to key store 160.

Although not explicitly illustrated in FIG. 3, the other two external values than the control key, EncCK and/or EncMKz, also may be stored in key store 160 or otherwise used beyond module 150. This type of tiered, key ladder implementation may provide multiple levels of indirection and protection from attacks.

Returning to FIG. 2, second crypto module 240 may, in some implementations, be the same as crypto module 230 and may use the same private key 210 as first module 230 does. In such implementations, for example, second module 240 also may be associated with a set of run time keys 220. Such may enable second module 240 to produce a similarly protected control key at roughly the same time as first module 230 is producing its control key. Such a parallel control key-generation capability provided by modules 230 and 240 may reduce or eliminate latency when switching contexts (i.e., control keys) in the same stream of media information.

In MPEG-2 compliant transport streams (and in other streams compliant with video standards that use the same context switching scheme), for example, a flag exists to indicate an whether to use an even or odd key for decryption. This flag allows messages with new even or odd keys to be sent in advance of the flag changing so that the messages will be processed and the new even/odd keys available when the flag changes state in the stream. The presence of similarly-configured control module 240 may enable producing the next even or odd control key for a stream of media information, without having to wait for control module 230 to finish generating its even or odd control key.

Along these lines, additional similarly-configured modules 250, 260, etc. (not shown) may facilitate parallel generation of control keys for distinct streams, for example, from the same vendor. The presence of multiple, similarly-configured crypto modules (e.g., 230, 240, etc.) may permit a vendor to send groups of run-time keys 220 at the same time for generating multiple control keys for the same stream or for different streams, to be stored in key store 160.

Also, a crypto module, such as nth crypto module 290 (n being an integer two or greater), may be configured differently for another private key 210 from a different vendor of media information. The depth of a key ladder in such module 290 may be different from those in other modules 230, 240, etc. Such a “second type” of crypto module 290 may be duplicated in security module 150 to allow for parallel processing of even/odd control keys, for example. It may also facilitate latency-free control key generation among different vendors who do not coordinate their run time key messages, which may arrive at the same time. Crypto module 290 may also write the control keys that it produces to key store 160.

Key store 160 may include sufficient storage to store more than one control key from each of crypto modules 230-290. Key store 160 may be implemented, for example, via random access memory (RAM) or via a number of parallel buffers (e.g., first-in, first-out (FIFO) buffers). However key store 160 is implemented, it should be able to be written to, simultaneously if needed, by each connected crypto module 230-290. As such, key store 160 may have a number of different, independent input lines or ports.

Similarly, it may be desirable for processor(s) 140 to decrypt and/or switch the context of more than one stream at the same time. Hence, key store 160 may have a number of output lines or ports through which control keys or control words may be read, simultaneously if needed.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the invention.

For example, although “vendors” of media information have been referred to as providing the private keys discussed herein, the private keys may instead be provided by the rights owners of such information, and the media information may actually be provided by a “distributor” or other entity in a business relationship with the owner of the content. As used herein, the term “vendor” is intended to be broadly applied to any entity involved with distributing the encrypted media information and associated, even tangentially, with the private keys.

In a similar vein, “manufacturer” is intended to denote a party associated with providing at least security module 150, and who is a party to a shared-secret private key. For example, different entities may in fact make module 150 and other parts of device 110. As used herein, the term “manufacturer” may apply to any of these entities.

Further, at least some of the acts in FIG. 4 may be implemented as instructions, or groups of instructions, implemented in a machine-readable medium.

No element, act, or instruction used in the description of the present application should be construed as critical or essential to the invention unless explicitly described as such. Also, as used herein, the article “a” is intended to include one or more items. Variations and modifications may be made to the above-described implementation(s) of the claimed invention without departing substantially from the spirit and principles of the invention. All such modifications and variations are intended to be included herein within the scope of this disclosure and protected by the following claims.

What is claimed:

1. An apparatus, comprising:
circuitry to hold a private key associated with first media information;
a cryptographic module to operate on the private key to generate a plurality of first control keys for decrypting the first media information; and
a key store to hold the plurality of first control keys from the cryptographic module.

2. The apparatus of claim 1, wherein the first cryptographic module includes:
a ladder of two or more tiered cipher units to receive the private key and to generate the plurality of first control keys.

3. The apparatus of claim 2, further comprising:
storage to hold two or more run time keys that are inputs to the two or more tiered cipher units in the first ladder.

4. The apparatus of claim 1, further comprising:
a ladder of three or more tiered cipher units to receive the private key and to generate a plurality of second control keys,
wherein the key store is arranged to hold the plurality of second control keys.

5. The apparatus of claim 4, further comprising:
storage to hold three or more run time keys that are inputs to the three or more tiered cipher units in the second ladder.

6. The apparatus of claim 1, further comprising:
a processor to use the plurality of first control keys for context switching when decrypting the first media information.

7. An apparatus, comprising:
circuitry to permanently and inaccessibly store a private key that is a shared secret between a manufacturer of the circuitry and a vendor of a stream of encrypted media information;
a first cryptographic module to operate on the private key to generate a first control key for decrypting the stream of encrypted media information;
a second cryptographic module to operate on the private key to generate a second control key for decrypting the stream of encrypted media information; and
a key store to hold the first control key from the first cryptographic module and the second control key from the second cryptographic module.

8. The apparatus of claim 7, further comprising:
a memory to hold plural run time keys from the vendor that are inputs to the first cryptographic module or the second cryptographic module.

9. The apparatus of claim 7, further comprising:
a processor to decrypt the stream of encrypted media information using the first control key and the second control key.

10. The apparatus of claim 9, wherein processor is arranged to decrypt a first portion of the stream of encrypted media information using the first control key and the to decrypt a second portion of the stream of encrypted media information using the second control key.

11. The apparatus of claim 7, wherein key store is arranged to receive the first control key and the second control key simultaneously.

12. The apparatus of claim 7, wherein key store is arranged to output the first control key and the second control key simultaneously.

13. The apparatus of claim 7, wherein key store includes a plurality of buffers respectively associated with each cryptographic module.

14. The apparatus of claim 7, further comprising:
a third cryptographic module to operate on the private key to generate a third control key for decrypting another stream of encrypted media information,
wherein the key store is arranged to hold the third control key from the third cryptographic module.

15. A system to decrypt media streams, comprising:
at least one receiver to receive a first encrypted media stream and a second encrypted media stream;
a memory to store at least a portion of the first encrypted media stream and second encrypted media stream;
a security module to generate a first decryptor and a second decryptor, including:
circuitry to at least one private key,
a first crypto module to generate the first decryptor using the at least one private key, and
a second crypto module to generate the second decryptor using the at least one private key;
a storage unit to store the first decryptor and the second decryptor at the same time; and
a processor to decrypt the first encrypted media stream using the first decryptor and to decrypt the second encrypted media stream using the second decryptor.

16. The system of claim 15, wherein the at least one receiver includes:
a first receiver to receive the first encrypted media stream, and
a second receiver to receive the second encrypted media stream at substantially the same time.

17. The system of claim 15, wherein the first crypto module includes:
a ladder of plural cipher blocks to encrypt the at least one private key using plural run time keys.

18. The system of claim 15, wherein the storage unit is arranged to store a plurality of decryptors from the first crypto module.

19. The system of claim 15, wherein the storage unit is further arranged to store a plurality of decryptors from the second crypto module.
